(19) United States
(12) Patent Application Publication
(10) Pub. No.: US 2019/0129100 A1
(43) Pub. Date: May 2, 2019

(54) FLEXIBLE OPTICAL CIRCUIT DEVICE

(71) Applicant: Gloriole Electroptic Technology Corp., Kaohsiung City (TW)

(72) Inventor: Shu-Hui HSU, Kaohsiung City (TW)

(21) Appl. No.: 16/178,033

(22) Filed: Nov. 1, 2018

(30) Foreign Application Priority Data
Nov. 2, 2017 (TW) 106137849

(51) Int. Cl. G02B 6/36; G02B 6/40

(52) U.S. Cl. CPC G02B 6/3608; G02B 6/40

(57) ABSTRACT

A flexible optical circuit device includes a substrate, a plurality of optical fibers, and at least one connector unit. The substrate has a main portion and at least one support portion extending from the main portion. The optical fibers are disposed on the substrate and extend from the main portion to the at least one support portion. The at least one connector unit includes a retaining member that is formed with a through hole. The optical fibers and the at least one support portion extend through the through hole.

### CROSS-REFERENCE TO RELATED APPLICATION

This application claims priority of Taiwanese Patent Application No. 106137849, filed on Nov. 2, 2017.

### FIELD

The disclosure relates to an optical circuit device, more particularly to a flexible optical circuit device.

### BACKGROUND

Referring to FIG. 1, a conventional flexible optical circuit device includes a board 10 having two opposite edges 101, a plurality of optical fibers 11 disposed on the board 10, and a plurality of connectors 12 for insertion of the plurality of optical fibers 11 thereinto. Two opposite ends of each of the optical fibers 11 extend beyond the edges 101, respectively. The assembly of the conventional flexible optical circuit device may be made more efficient by automating the disposition of the optical fibers 11 on the board 10. By virtue of this automation and by making the board 10 out of a lightweight and thin material, the conventional optical circuit device may easily be modularized. The assembly of an optical network may be quickly accomplished by connecting the connectors 12 to another device.

Referring to FIG. 2, even though the conventional flexible optical circuit device has the above benefits, the plurality of optical fibers 11 are made of a soft and easily-curved material. When a bundle of the optical fibers 11 needs to be inserted through the corresponding connector 12, the optical fibers 11 may be curved by force of the insertion. If the bundle of optical fibers 11 is not precisely aligned with the connector 12, or if any one of the optical fibers 11 in the bundle becomes curved, the optical fibers 11 would not be properly inserted into the connector 12, thus it often takes multiple tries before a successful insertion. Further due to the soft nature of the optical fibers 11, without other elements to support the bundle of optical fibers 11, the strength of the connection between the optical fibers 11 and the connector 12 may be weak.

### SUMMARY

Therefore, the object of the disclosure is to provide a flexible optical circuit device that can alleviate at least one of the drawbacks of the prior art.

According to the disclosure, the flexible optical circuit device includes a substrate, a plurality of optical fibers, and at least one connector unit.

The substrate has a main portion and at least one support portion extending from the main portion.

The optical fibers are disposed on the substrate and extend from the main portion to the at least one support portion.

The at least one connector unit includes a retaining member that is formed with a through hole. The optical fibers and the at least one support portion extend through the through hole.

### BRIEF DESCRIPTION OF THE DRAWINGS

Other features and advantages of the disclosure will become apparent in the following detailed description of the embodiment with reference to the accompanying drawings, of which:

FIG. 1 is a fragmentary, partly exploded top view of a conventional flexible optical circuit device;

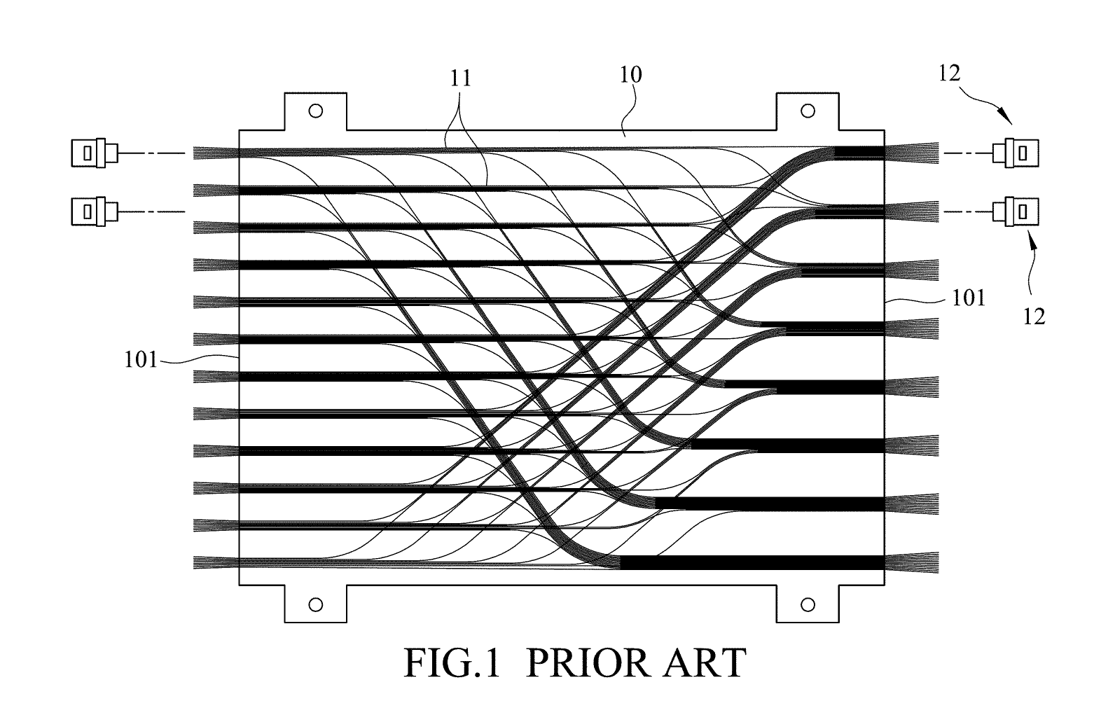

FIG. 2 is a another fragmentary, partly exploded top view of the conventional flexible optical circuit device;

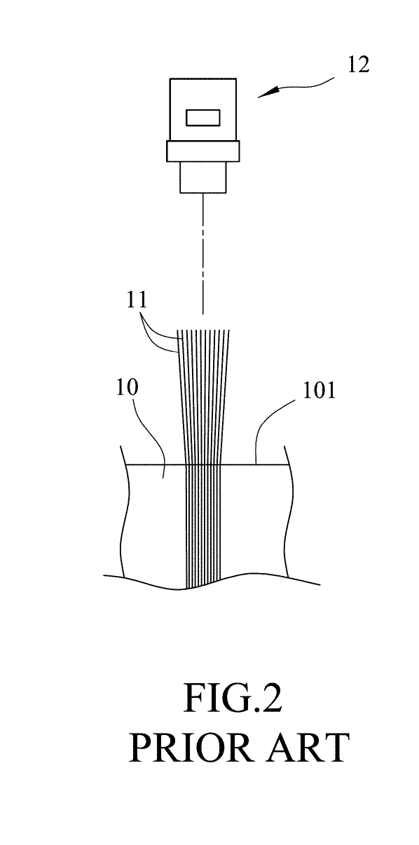

FIG. 3 is a fragmentary, partly exploded perspective view of an embodiment of a flexible optical circuit device;

FIG. 4 is a fragmentary exploded side view, illustrating a support portion of a substrate, a plurality of optical fibers, and a connector unit of the embodiment; and

FIG. 5 is a top view of the embodiment.

### DETAILED DESCRIPTION

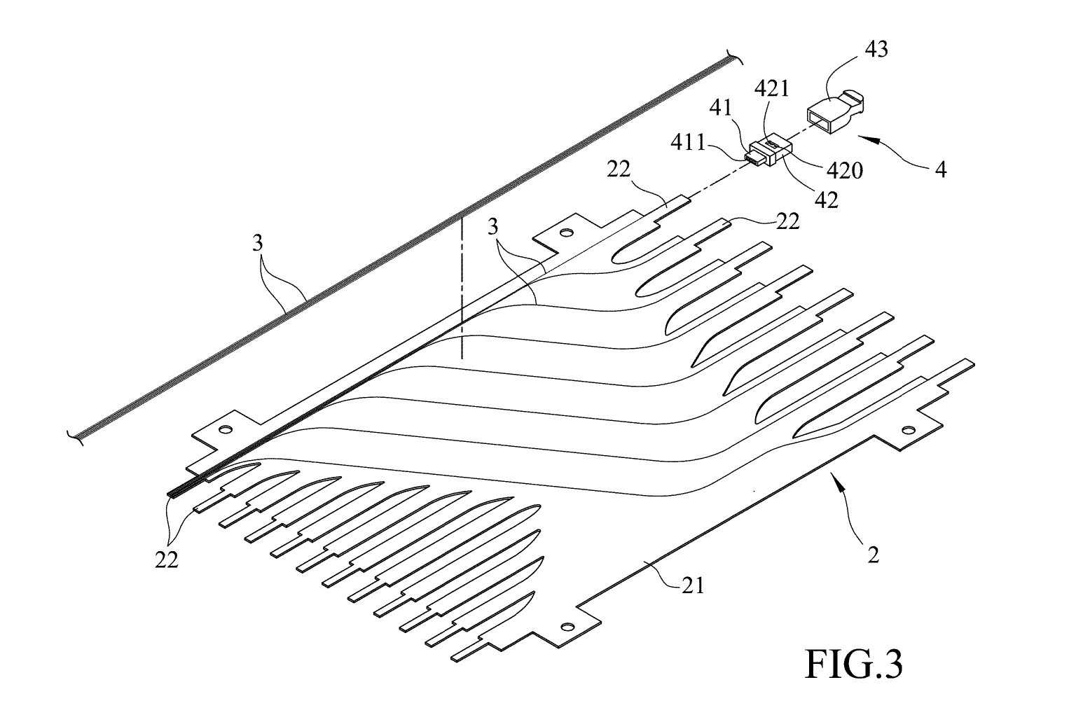

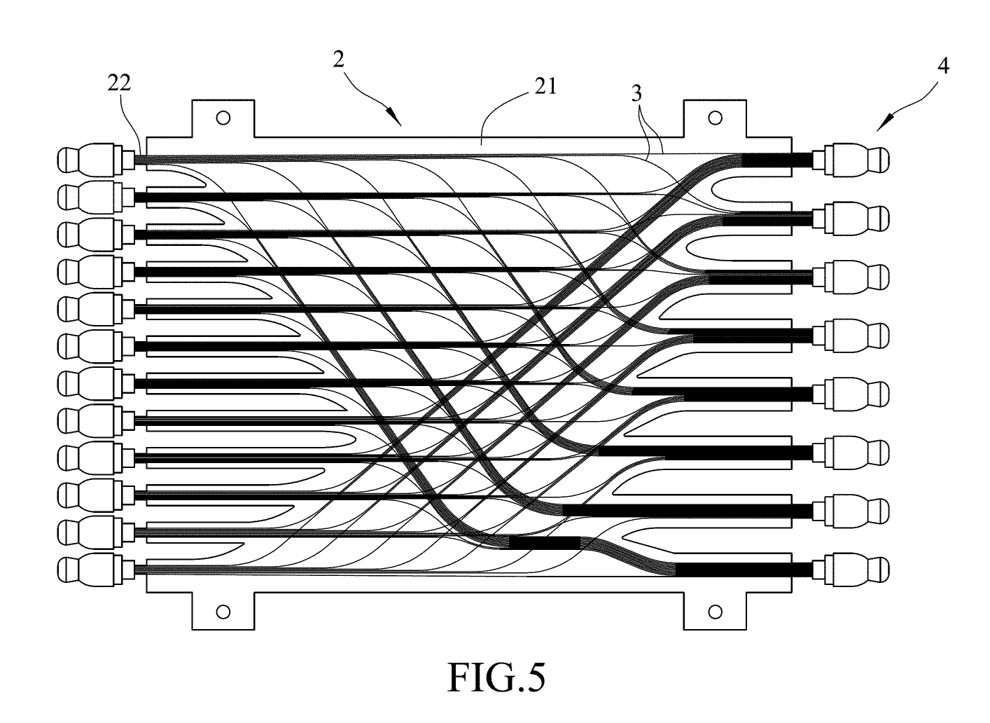

Referring to FIG. 3, an embodiment of a flexible optical circuit device according to the present disclosure includes a substrate 2, a plurality of optical fibers 3 disposed on the substrate 2, and a plurality of connector units 4 (see FIG. 5). The substrate 2 has a main portion 21 and a plurality of spaced-apart support portions 22 extending from the main portion 21. The optical fibers 3 are disposed on the main portion 21 of the substrate 2, and secured to the substrate 2 by, for example, a spray adhesive. However, how the optical fibers 3 are disposed onto the substrate 2 is not the focus of this disclosure and would not be further discussed.

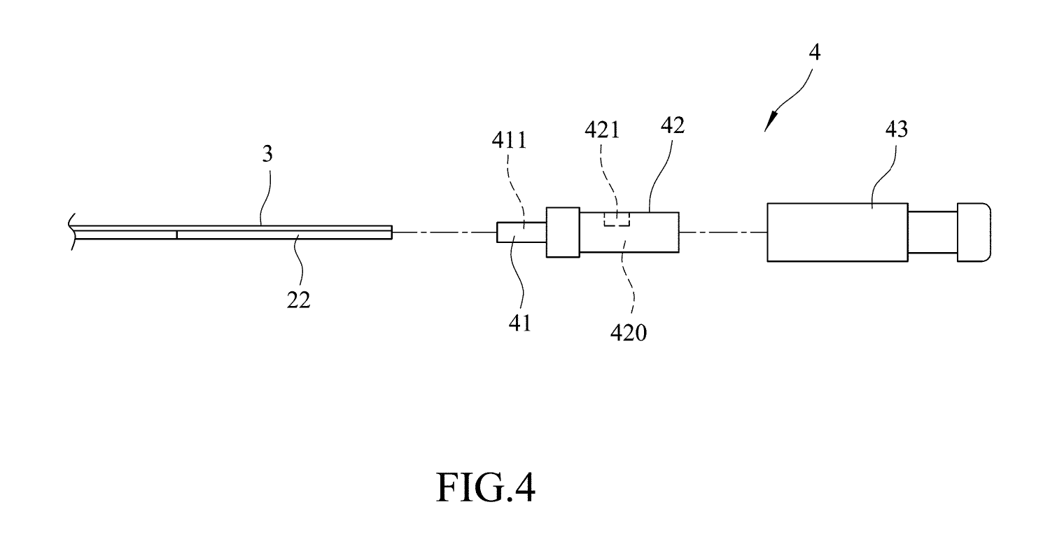

Referring to FIGS. 3 and 4, during the manufacturing process of the flexible optical circuit, after the optical fibers 3 are secured to the substrate 2, the optical fibers 3 are divided into a plurality of bundles each including a portion of the optical fibers 3. The bundles extend from the main portion 21 to the plurality of support portions 22, respectively. In other embodiments, the optical fibers 3 are all contained in one bundle, the bundle being supported by one of the support portion 22 and connected to one connector unit 4. Each of the connector units 4 includes a retaining member 41 that is formed with a through hole 411, an insertion member 42, and a protective sleeve 43 that removably covers the insertion member 42. The insertion member 42 is molded as one piece with the retaining member 41 and defines a receiving space 420 that is in spatial communication with the through hole 411. Each bundle of the optical fibers 3 and a respective one of the support portions 22 extend through the through hole 411 into the receiving space 420 of a respective one of the connector units 4.

When one of the bundles of the optical fibers 3 and the respective one of the support portions 22 are inserted into the through hole 411 of the retaining member 41 of the respective one of the connector units 4, since the optical fibers 3 in the bundle are adhered to each other and to the support portion 22, it is less likely for one of the optical fibers 3 to curve, and thus a successful insertion is more likely. Furthermore, with the support of the support portions 22, connections between the optical fibers 3 and the retaining members 41 are strengthened.

The insertion member 42 of each of the connector units 4 has a filling hole 421 in spatial communication with the receiving space 420 for permitting injection of adhesive therethrough into the receiving space 420 to secure a respective one of the bundles of the optical fibers 3 and a respective one of the support portions 22 to the insertion member 42.

Referring to FIGS. 4 and 5, the assembly of the flexible optical circuit device and the modularization of an optical network are completed when the optical fibers 3 are securely inserted through the connector units 4. The insertion member 42 of each of the connector units 4 may be connected to a specific optical communication device (not shown), completing the installation of an optical fiber network. For each connector unit 4, when the insertion member 42 is not connected to the specific optical communication device, the insertion member 42 may be covered by the protective sleeve 43 to prevent dust, moisture and other undesirable particles from affecting the function of the embodiment.

In sum, with the support portions 22 of the substrate 2 providing support to the optical fibers 3, the probability of successfully inserting one of the bundles of the optical fibers 3 and the respective one of support portion 22 into the respective one of the connector units 4 is increased. Further, the connection strength between the optical fibers 3 and the connector units 4 is also improved.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A flexible optical circuit device, comprising:
a substrate having a main portion, and at least one support portion that extends from said main portion;
a plurality of optical fibers disposed on said substrate and extending from said main portion to said at least one support portion; and
at least one connector unit including a retaining member that is formed with a through hole, said optical fibers and said at least one support portion extending through said through hole.

2. The flexible optical circuit device as claimed in claim 1, wherein said at least one connector unit further includes an insertion member, said insertion member and said retaining member being molded as one piece, said insertion member defining a receiving space that is in spatial communication with said through hole, said optical fibers and said at least one support portion extending through said through hole into said receiving space.

3. The flexible optical circuit device as claimed in claim 2, wherein said insertion member has a filling hole being in spatial communication with said receiving space for permitting injection of adhesive therethrough into said receiving space to secure said optical fibers and said at least one support portion to said insertion member.

4. The flexible optical circuit device as claimed in claim 2, wherein said at least one connector unit further includes a protective sleeve removably covering said insertion member.

5. The flexible optical circuit device as claimed in claim 1, wherein:
said flexible optical circuit device comprises a plurality of said connector units;
said substrate has a plurality of said support portions being spaced apart from each other; and
said through hole of each of said connector units receives a portion of said optical fibers and a respective one of said support portions of said substrate.
